(19) United States
(12) Patent Application Publication
(10) Pub. No.: US 2026/0122742 A1
(43) Pub. Date: Apr. 30, 2026

(54) LED CONTROL CIRCUIT AND LIGHTING DEVICE HAVING SAME

(71) Applicant: Grit Technology Corporation, New Taipei City (TW)

(72) Inventors: Te Sheng Huang, New Taipei City (TW); Jian-Hong Hu, New Taipei City (TW)

(21) Appl. No.: 18/927,357

(22) Filed: Oct. 25, 2024

(51) Int. Cl. H05B 45/30; H05B 45/10; H05B 45/20; H05B 45/50; H05B 47/24

(52) U.S. Cl. CPC H05B 45/30; H05B 45/10; H05B 45/20; H05B 45/50; H05B 47/24

(57) ABSTRACT

An LED control circuit is electrically connected to an AC power and configured to control a light-emitting module. The LED control circuit includes a differential mode surge protection module, a common mode surge protection module, a rectification and filter circuit, a strobe control circuit, an overvoltage protection circuit, a signal collection circuit, an LED drive control circuit, a communication isolation circuit, and a color temperature and brightness processing circuit including a main control IC and an auxiliary control IC. The main control IC collects external signals, processes the signals, and transmits the processed signals to the auxiliary control IC. The auxiliary control IC adjusts brightness and color temperature of the light-emitting module by activating the LED drive control circuit. A lighting device having the LED control circuit is also provided.

### FIELD OF THE INVENTION

The invention relates to lighting devices and more particularly to a light-emitting diode (LED) control circuit and a lighting device having same.

### BACKGROUND OF THE INVENTION

Nowadays lamps on the market comprise incandescent lamps, energy-saving lamps, and LED lamps. Among them, the market share of incandescent lamps has been declining gradually due to short lifespan, poor stability, comfort, and high power consumption. Energy-saving lamps contain heavy metals such as mercury which seriously pollutes the environment after they are discarded, thereby adversely affecting their use.

LED lamps are equipped with control circuits and drive modules which convert the mains power into voltage and current suitable for LED lamps, thereby activating the LED lamps to emit light. This makes the cost of LED lamps relatively high and adversely affects their popularity among consumers.

Further, the control circuit only has two states, i.e., on and off. This makes it difficult for LED lamps to achieve a dimmable state. Even if there are dimmable LED lamps, their dimming effect is not good. They usually only have on and off functions. Thus, it makes the dimmable LED lamp difficult to meet user needs.

LED lamps are necessity of modern life. Conventional lamps have relatively single functions. Simple LED lamps only have on and off functions. Thus, they do not meet the user needs.

In addition, conventional LED lamps generally only control a certain color temperature. That is, individual cold white light or individual warm white light. Some LEDs have a lamp bead of two colors which usually are one cool white light lamp bead and one warm white light lamp bead. By directly powering a desired lamp bead, it can present one color temperature, and by switching a switch, it can present the other color temperature. However, this simple switching can only achieve two color temperatures. Its effect is limited to a limited number of color temperature changes.

Thus, the need for improvement still exists.

### SUMMARY OF THE INVENTION

It is therefore one object of the invention to provide an LED control circuit having the advantages including capable of adjusting brightness and color temperature and having many different color temperature changes. Further, a lighting device comprising the LED control circuit is provided. The invention utilizes a wired power, the LED control circuit, and an LED lamp bead. The LED based lighting device saves energy, is environmentally friendly, has a prolonged useful life, and has a great share of lamp market.

For achieving above and other objects, the invention provides an LED control circuit, electrically connected to an AC power and configured to control a light-emitting module, comprising a differential mode surge protection module; a common mode surge protection module; a rectification and filter circuit; a strobe control circuit; an overvoltage protection circuit; a signal collection circuit; an LED drive control circuit; a communication isolation circuit; and a color temperature and brightness processing circuit including a main control IC and an auxiliary control IC; wherein the main control IC is configured to collect external signals, process the signals, and transmit the processed signals to the auxiliary control IC; and wherein the auxiliary control IC is configured to adjust brightness and color temperature of the light-emitting module by activating the LED drive control circuit.

Preferably, the signal collection circuit is configured to sense whether the AC power is into operation or not in a predetermined time; wherein in response to sensing the operation of the AC power, a signal is transmitted from the signal collection circuit to the control circuit; wherein the LED control circuit is connected to the light-emitting module for controlling on or off of the light-emitting module and brightness of the light-emitting module, and for adjusting color temperature of the light-emitting module.

Preferably, the color temperature and brightness processing circuit utilizes the main control IC and the auxiliary control IC to control color temperature and brightness; and wherein the main control IC and the auxiliary control IC are configured to activate the signal collection circuit to sense whether the AC power is into operation or not in the predetermined time, and adjust color temperature of the light-emitting module, thereby making a plurality of different color temperature changes.

Preferably, the differential mode surge protection module and the common mode surge protection module are provided upstream of the rectification and filter circuit.

It is another object of the invention to provide a lighting device comprising a light-emitting module and the LED control circuit electrically connected to the light-emitting module.

The invention has the following advantages and benefits in comparison with the conventional art: LED based lighting device saves energy, is environmentally friendly, has a prolonged useful life, and has a great share of lamp market. The LED control circuit is connected to the AC power to activate the LED based lighting device without an additional power source. This not only greatly decreases the manufacturing cost of LED but also greatly decrease the size of the LED based lighting device. The main control IC and the auxiliary control IC utilizes a multi-stage control mode to implement a dimmable control and increase light adjustment performance. The strobe control circuit greatly decreases flash frequency of the LED based lighting device and decreases hurt to the eyes. The LED control circuit is capable of effectively controlling dimming effect and decreasing flash frequency of the LED based lighting device. The LED control circuit is cost effective.

The above and other objects, features and advantages of the invention will become apparent from the following detailed description taken with the accompanying drawings.

### BRIEF DESCRIPTION OF THE DRAWINGS

FIG. 1 is a block diagram of a lighting device according to a first preferred embodiment of the invention;

FIG. 2 is a circuit diagram of the lighting device; and

FIG. 3 is a circuit diagram of certain components of a lighting device according to a second preferred embodiment of the invention.

### DETAILED DESCRIPTION OF THE INVENTION

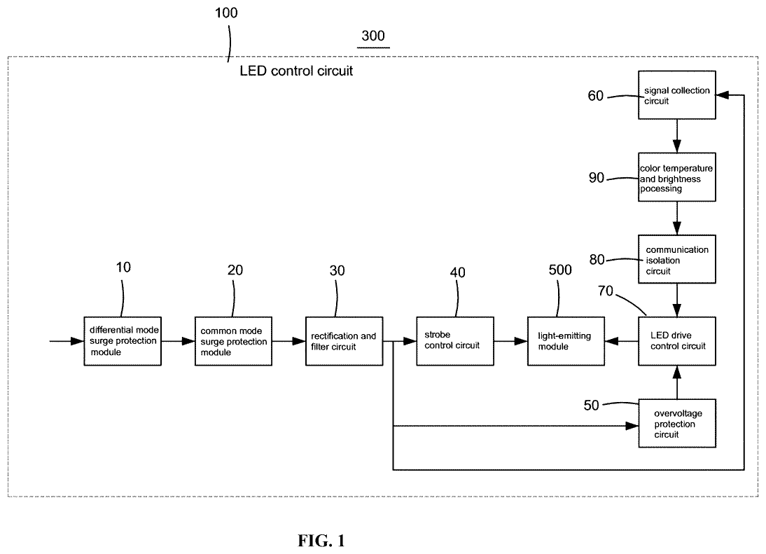

Referring to FIG. 1, a lighting device 300 according to a first preferred embodiment of the invention is shown. The lighting device 300 comprises an LED control circuit 100 and a light-emitting module 500 electrically connected to the LED control circuit 100 as discussed in detail below. In the embodiment, the LED control circuit 100 electrically connected to an alternating current (AC) power and is configured to control the light emission of the light-emitting module 500. The LED control circuit 100 includes a differential mode surge protection module 10 and a common mode surge protection module 20 connected to the differential mode surge protection module 10. Thus, the light-emitting module 500 can be controlled to activate or not and further brightness of the light-emitting module 500 can be controlled. The common mode surge protection module 20 is connected to the light-emitting module 500 and is configured to sense whether the AC power is on or not in a predetermined time. In response to sensing the on of the AC power, the common mode surge protection module 20 adjusts a color temperature of the light-emitting module 500.

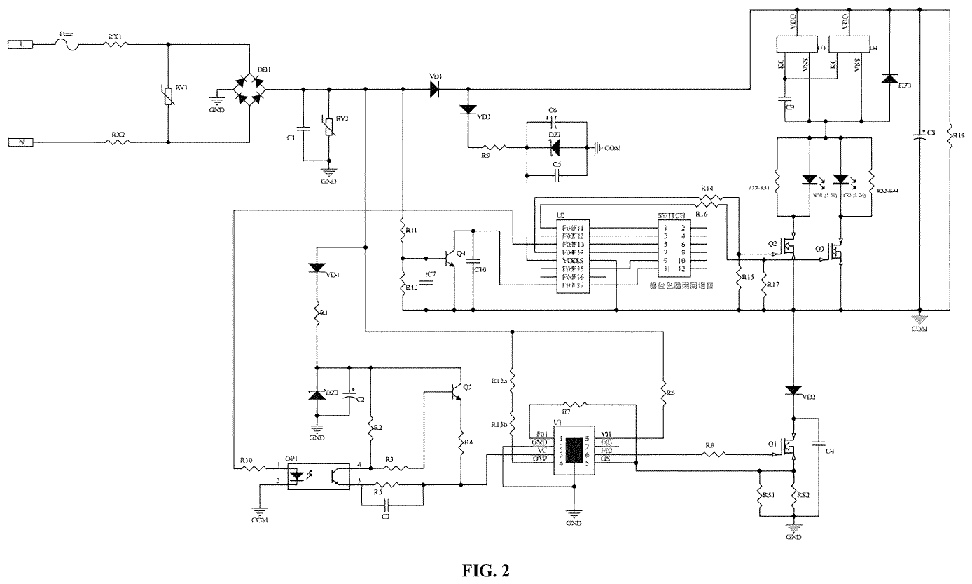

Referring to FIG. 2 in conjunction with FIG. 1, the LED control circuit 100 is electrically connected to the AC power via an ACL terminal and an ACN terminal. Thus, an LED lighting device can be powered by the AC power to emit light. The LED control circuit 100 includes the differential mode surge protection module 10, the common mode surge protection module 20, a rectification and filter circuit 30, a strobe control circuit 40, an overvoltage protection circuit 50, a signal collection circuit 60, an LED drive control circuit 70, a communication isolation circuit 80, and a color temperature and brightness processing circuit 90 having a main control integrated circuit (IC) and an auxiliary control IC. The main control IC collects external signals and processes same. And in turn, the processed signals are transmitted to the auxiliary control IC. Thus, the auxiliary control IC may adjust brightness and color temperature of the light-emitting module 500 via the LED drive control circuit 70. Further, compatibility of the auxiliary control IC is increased.

The signal collection circuit 60 is configured to sense whether the AC power is on or not in a predetermined time. In response to sensing the on of the AC power, a signal is transmitted to the LED control circuit 100. The LED control circuit 100 includes the color temperature and brightness processing circuit 90. The LED control circuit 100 is connected to the light-emitting module 500 for controlling on or off of the light-emitting module 500, brightness of the light-emitting module 500, and adjust color temperature of the light-emitting module 500.

Further, the invention provides the lighting device 300 comprising the LED control circuit 100 and the light-emitting module 500 electrically connected to the LED control circuit 100.

The LED control circuit 100 and the lighting device 300 having the LED control circuit 100 also have the functions of adjusting brightness and color temperature, i.e., multifunctional. Further, the LED control circuit 100 may activates the signal collection circuit 60 via the main and auxiliary IC modes. The signal collection circuit 60 may sense whether the AC power is on, the LED control circuit 100 may control color temperature change of the light-emitting module 500, thereby achieving a number of color temperature changes.

The invention further comprises the differential mode surge protection module 10 and the common mode surge protection module 20 which are provided upstream of the rectification and filter circuit 30. Thus, the invention has a greatly increased surge protection performance such as in the range of AC 3 KV.

In the embodiment, the LED control circuit 100 further comprises the rectification and filter circuit 30 disposed downstream of the common mode surge protection module 20. The rectification and filter circuit 30 is configured to rectify and filter AC supplied from the common mode surge protection module 20. The rectified and filtered AC is transmitted to the strobe control circuit 40, the overvoltage protection circuit 50, and the signal collection circuit 60 respectively. Further, the AC is transmitted from the strobe control circuit 40 to the light-emitting module 500.

It is noted that the LED control circuit 100 further comprises the differential mode surge protection module 10 and the common mode surge protection module 20 which is disposed upstream of the rectification and filter circuit 30. Thus, the LED control circuit 100 is prevented from being interfered by electromagnetic interference (EMI) and capable of inhibiting surge. As a result, transient, stable protection is provided to the lighting device 300.

It is noted that the LED control circuit 100 further comprises the strobe control circuit 40 interconnecting the rectification and filter circuit 30 and the light-emitting module 500. The strobe control circuit 40 is configured to prevent strobe light from being generated by the light-emitting module 500.

It is noted that the LED control circuit 100 further comprises the overvoltage protection circuit 50 disposed between the rectification and filter circuit 30 and the LED drive control circuit 70. The overvoltage protection circuit 50 is configured to supply a stable voltage to the LED drive control circuit 70 which in turn supplies same to the light-emitting module 500.

In operation of the lighting device 300, the differential mode surge protection module 10 is connected to L terminal and N terminal of the AC power. Thus, AC is supplied to the differential mode surge protection module 10, the common mode surge protection module 20, and the rectification and filter circuit 30 sequentially. Further, the rectified and filtered AC is supplied to the light-emitting module 500 via the strobe control circuit 40, and supplied to the light-emitting module 500 via the overvoltage protection circuit 50 and the LED drive control circuit 70 respectively. The differential mode surge protection module 10 utilizes a switch to control on and off of the light-emitting module 500, and change resistance of a resistor to adjust brightness of the light-emitting module 500. When the AC is interrupted, the differential mode surge protection module 10 switches the switch to off in order to turn off the light-emitting module 500. The common mode surge protection module 20 is configured to sense whether the AC power is on or not in a predetermined time. In response to sensing the operation of the AC power, the common mode surge protection module 20 adjusts a color temperature of the light-emitting module 500.

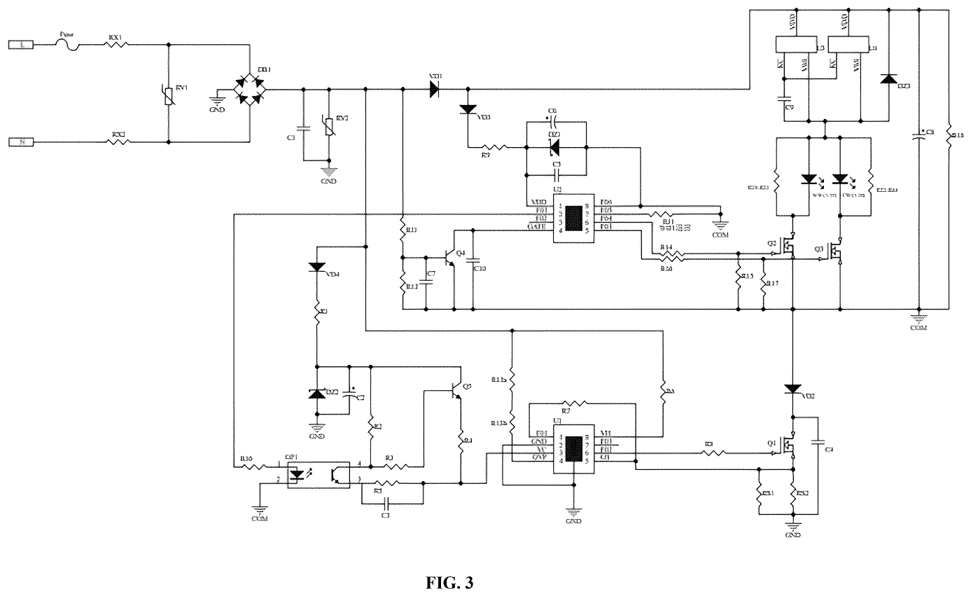

Referring to FIG. 3, a circuit diagram of certain components of a lighting device 600 according to a second preferred embodiment of the invention is shown. The lighting device 600 is structurally similar to the lighting device 300 of the first preferred embodiment. The LED control circuit 100 and the lighting device 600 having the LED control circuit 100 also have the functions of adjusting brightness and color temperature, i.e., multifunctional. Further, the common mode surge protection module 20 may sense whether the AC power is on or not. If the AC power is on, the LED control circuit 100 may control color temperature change of the light-emitting module 500, thereby achieving a number of color temperature changes.

The invention has the following advantages and benefits in comparison with the conventional art:

The color temperature and brightness processing circuit 90 of the LED control circuit 100 has two ICs in which one is master and the other is slave. That is, one IC controls the other IC.

The overvoltage protection circuit 50 of the LED control circuit 100 is dispsed between the rectification and filter circuit 30 and the LED drive control circuit 70.

The communication isolation circuit 80 of the LED control circuit 100 is disposed between the LED drive control circuit 70 and the color temperature and brightness processing circuit 90.

The signal collection circuit 60 of the LED control circuit 100 is disposed between the rectification and filter circuit 30 and the color temperature and brightness processing circuit 90, configured to collect signals from different sources, and compatible to most controllable silicon.

The LED control circuit 100 includes the differential mode surge protection module 10 and the common mode surge protection module 20 which are provided upstream of the rectification and filter circuit 30. The LED control circuit 100 has a greatly increased surge protection performance such as in the range of AC 3 KV.

While the invention has been described in terms of preferred embodiments, those skilled in the art will recognize that the invention can be practiced with modifications within the spirit and scope of the appended claims.

What is claimed is:

1. An LED control circuit, electrically connected to an AC power and configured to control a light-emitting module, comprising:
a differential mode surge protection module;
a common mode surge protection module;
a rectification and filter circuit;
a strobe control circuit;
an overvoltage protection circuit;
a signal collection circuit;
an LED drive control circuit;
a communication isolation circuit; and
a color temperature and brightness processing circuit including a main control IC and an auxiliary control IC;
wherein the main control IC is configured to collect external signals, process the signals, and transmit the processed signals to the auxiliary control IC; and
wherein the auxiliary control IC is configured to adjust brightness and color temperature of the light-emitting module by activating the LED drive control circuit.

2. The LED control circuit of claim 1, wherein the signal collection circuit is configured to sense whether the AC power is into operation or not in a predetermined time; wherein in response to sensing the operation of the AC power, a signal is transmitted from the signal collection circuit to the control circuit; wherein the LED control circuit is connected to the light-emitting module for controlling on or off of the light-emitting module and brightness of the light-emitting module, and for adjusting color temperature of the light-emitting module.

3. The LED control circuit of claim 2, wherein the color temperature and brightness processing circuit utilizes the main control IC and the auxiliary control IC to control color temperature and brightness; and wherein the main control IC and the auxiliary control IC are configured to activate the signal collection circuit to sense whether the AC power is into operation or not in the predetermined time, and adjust color temperature of the light-emitting module, thereby making a plurality of different color temperature changes.

4. The LED control circuit of claim 1, wherein the differential mode surge protection module and the common mode surge protection module are provided upstream of the rectification and filter circuit.

5. The LED control circuit of claim 1, wherein the overvoltage protection circuit is disposed between the rectification and filter circuit and the LED drive control circuit.

6. The LED control circuit of claim 1, wherein the signal collection circuit is disposed between the rectification and filter circuit and the color temperature and brightness processing circuit and configured to collect signals from different sources.

7. The LED control circuit of claim 1, wherein the communication isolation circuit is disposed between the LED drive control circuit and the color temperature and brightness processing circuit.

8. A lighting device having an LED control circuit of claim 1, comprising a light-emitting module and the LED control circuit electrically connected to the light-emitting module.
